(19) United States
(12) Patent Application Publication
(10) Pub. No.: US 2026/0097691 A1
(43) Pub. Date: Apr. 9, 2026

(54) VEHICLE SEAT ASSEMBLY HAVING CUSHION TUBE WITH SUPPORT BRACKETS

(71) Applicant: Ford Global Technologies, LLC, Dearborn, MI (US)

(72) Inventors: Sushil Shastry, Brighton, MI (US); Philip Skinner, Plymouth, MI (US); Kurt Leon Kormos, Milford, MI (US); Srikanth Ramanadham, Farmington, MI (US)

(73) Assignee: Ford Global Technologies, LLC, Dearborn, MI (US)

(21) Appl. No.: 18/910,137

(22) Filed: Oct. 9, 2024

(51) Int. Cl. B60N 2/02; B60N 2/72

(52) U.S. Cl. CPC B60N 2/02; B60N 2/72

(57) ABSTRACT

A vehicle seat assembly has a base support structure configured to be supported on a floor of a vehicle. A rear cushion tube is coupled to the base support structure. A front cushion tube is coupled to the rear cushion tube defining a cushion support structure. The front cushion tube has a generally U-shaped portion with a first end and a second end. The front cushion tube may rotate between a seating position and an upright stowed position. A first pivot bracket is pivotably coupled to the first end of the front cushion tube to the base support structure. A second pivot bracket is pivotably coupled to the second end of the front cushion tube to the base support structure.

### FIELD OF THE DISCLOSURE

The present disclosure generally relates to vehicle seating, and more particularly relates to a vehicle seating assembly having a seat with a cushion support tube that rotates between a seating position and an upright stowed position.

### BACKGROUND OF THE DISCLOSURE

Motor vehicles are commonly equipped with seating assemblies that typically include a seat base and a seat back. In some motor vehicles such as pickup trucks, a flip-style seat may include a seat base that may fold from a seating position to an upright stowed position. The seat base typically includes a cushion support in the form of a cushion tube assembly that supports the seating area including seat pans and cushion. It may be desirable to provide for a vehicle seat that provides enhanced support of the cushion tube assembly.

### SUMMARY OF THE DISCLOSURE

According to a first aspect of the present disclosure, a vehicle seat assembly has a base support structure configured to be supported on a floor of a vehicle. A rear cushion tube is coupled to the base support structure. A front cushion tube is coupled to the rear cushion tube defining a cushion support structure. The front cushion tube has a generally U-shaped portion with a first end and a second end. The front cushion tube may rotate between a seating position and an upright stowed position. A first pivot bracket is pivotably coupled to the first end of the front cushion tube to the base support structure. A second pivot bracket is pivotably coupled to the second end of the front cushion tube to the base support structure.

Embodiments of the first aspect of the present disclosure can include any one or a combination of the following features:
the base support structure comprises at least one support bracket coupled to the base support structure and configured to support the underside of the front cushion tube in the seating position;
at least one support bracket comprises a first support bracket coupled to the base support structure on one end and a second support bracket coupled to the base support structure on an opposite second end;
at least one seat pan coupled to the rear cushion tube and the front cushion tube;
a seat cushion disposed on top of the front and rear cushion tubes and the at least one seat pan;
the first and second pivot brackets are coupled to the rear cushion tube and comprise a sleeve cooperatively engaging the first and send ends, respectively, of the front cushion tube;
a seat back supported by the base support structure;
the front cushion tube comprises Boron;
the front cushion tube comprises a steel alloy having Boron in an amount of 0.001 to 0.005 weight percent;
the front cushion tube comprises a metal alloy having Boron in an amount of 0.001 to 0.010 weight percent;
the first and second pivot brackets comprise a steel alloy having Boron; and
the front cushion tube has a generally rectangular cross-section.

According to a second aspect of the present disclosure, a vehicle seat assembly has a base support structure configured to be supported on a floor of a vehicle. A rear cushion tube is coupled to the base support structure. A front cushion tube is coupled to the lateral extending rod and defining a cushion support structure. The front cushion tube has a generally U-shaped portion with a first end and a second end. The front cushion tube may rotate between a seating position and an upright stowed position. A first pivot bracket pivotably couples the first end to the base support structure. A second pivot bracket pivotably couples the second end of the front cushion tube to the base support structure. The at least one support bracket comprises a first support bracket coupled to the base support structure on one end and a second support bracket coupled to the base support structure on an opposite second end.

Embodiments of the second aspect of the present disclosure can include any one or a combination of the following features:
at least one seat pan coupled to the rear cushion tube and the front cushion tube;
a seat cushion disposed on top of the front and rear cushion tubes and the at least one seat pan;
the first and second pivot brackets comprise a sleeve cooperatively engaging the first and send ends, respectively, of the front cushion tube;
the front cushion tube comprises Boron;
the front cushion tube comprises a steel alloy having Boron in an amount of at least 0.001 to 0.005 weight percent;
the cushion tube comprises a metal alloy having Boron in an amount of 0.001 to 0.010 weight percent; and
the front cushion tube has a generally rectangular cross-section.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side view of a motor vehicle in the form of a pickup truck having a rear row of seating configured with a flip-style seat assembly configured in a seating position, according to one example;

FIG. 2 is an upper front perspective view of the flip-style seat assembly shown in the seating position;

FIG. 3 is an upper perspective view of the seat base with front and rear cushion tubes and support brackets in the seating position;

FIG. 4 is a front view of the seat base with cushion tubes and bracket supports shown in FIG. 3;

FIG. 5 is a rear view of the seat base with cushion tubes and bracket supports shown in FIG. 3;

FIG. 6 is an upper perspective view of the first seat base having a front cushion tube with support brackets;

FIG. 7 is a lower rear perspective view of the left side of the first seat base further illustrating the support brackets;

FIG. 7A is an exploded perspective view of the first seat base with cushion tubes shown in FIG. 7;

FIG. 7B is a further exploded view of the first set base with cushion tubes shown in FIG. 7;

FIG. 8 is a lower rear perspective view of the right side of the first cushion tube and support brackets;

FIG. 8A is an exploded view of the first seat base with cushion tubes as shown in FIG. 8;

FIG. 8B is a further exploded view of the first set base with cushion tubes as shown in FIG. 8;

FIG. 9 is a transverse cross-sectional view taken through the front cushion tube and support bracket;

FIG. 9A is an exploded view of the support brackets removed from the cushion tube as shown in FIG. 9;

FIG. 10 is an exploded perspective view of the first seat base; and
FIG. 10A is an upper perspective view of the second seat base and support brackets.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

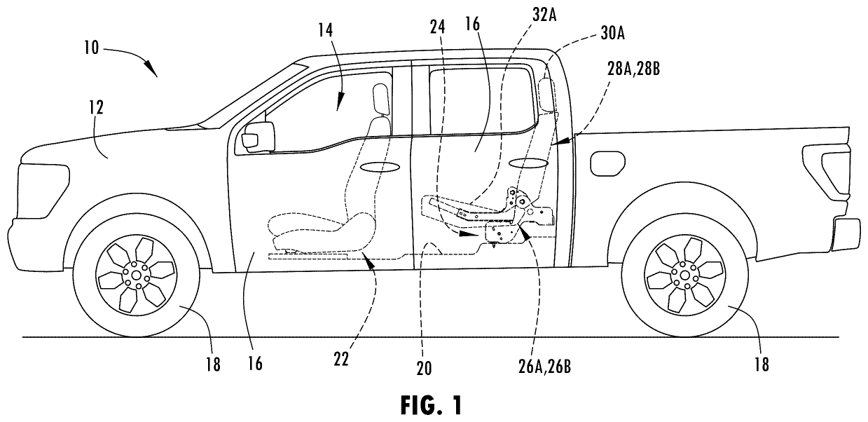

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle seat assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, an automotive or motor vehicle 10 is generally illustrated in the form of a pickup truck having a body 12 generally defining a cabin interior 14. The cabin interior 14 serves as a passenger compartment which includes a front row of seats 22 and a rear row of seats 24. The vehicle body 12 has access doors 16 on each of the opposite lateral left and right sides, generally proximate to the front row of seats 22 and the rear row of seats 24. The motor vehicle 10 has a plurality of road wheels 18 driven by one or more motors and is equipped to transport one or more passengers and cargo.

The motor vehicle 10 is configured with the rear row seat 24 in the form of a flip-style seat having two seating assemblies in the rear row of seats of the cabin interior 14. The rear row seat 24 is a seating assembly that includes first and second seat bases 26A and 26B and first and second upright seat backs 28A and 28B. The first and second seat bases 26A and 26B and seat backs 28A and 28B each are interconnected with a seat support structure such as brackets forming a frame which is supported on and connected to a floor 20 in the cabin interior 14. Each seat base is a flip-style seat base 26A and 26B that may be configured in a seating position as seen in FIG. 1, which is generally horizontal with a slight forward incline and may rotate about a pivot axis to flip to an upright stowed position which is generally vertical and oriented generally parallel to the corresponding seat backs 28A and 28B.

It should be appreciated that the rear row seat 24 is fastened to and supported on the floor 20 of the motor vehicle 10. The rear row seat 24 may have a space underneath the first and second seat bases 26A and 26B and on the floor 20 when the seat bases 26A and 26B are in the seating position. An under seat storage system may be utilized and disposed below the seat first and second bases 26A and 26B when in the seating position or cargo items may simply be stored on the floor 20 in the space below the seat bases 26A and 26B.

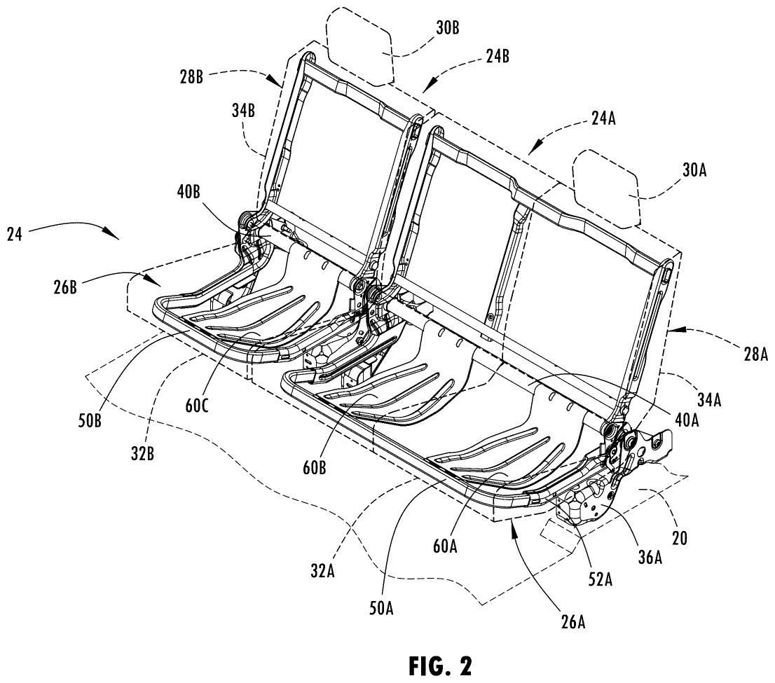

Referring to FIG. 2, the rear row seat 24 is illustrated having a larger first seat 24A and a smaller second seat 24B installed on the floor 20 arranged laterally side-by-side. The larger first and smaller second seats 24A and 24B may be referred to as 60/40 split seat configured for seating three occupants across the entire second row of seating 24. The first seat 24A has the first seat base 26A and the first seat back 28A. The first seat base 26A has a cushion 32A, and the first seat back 28A has a cushion 34A. The cushions 32A and 34A may be covered with a cover material such as a cloth, leather, vinyl or other covering material.

The second seat 24B has the second seat base 26B and the second seat back 28B. The second seat base 26B has a cushion 32B and the second seat back 28B has a cushion 34B. The larger first and smaller second seat bases 26A and 26B and corresponding seat backs 28A and 28B are proportioned with a 60/40 split seat back size configuration which make up the seat back across the entire second row of seating 24. As such, the first seat base 26A provides seat base support aligned with the first seat back 28A, and the second seat base 26B provides a seat base support aligned with the second seat back 28B. In addition, the first seat back 28A includes a headrest 30A on the top side thereof. The second seat back 28B likewise includes a headrest 30B on the top side thereof. The cushions 34A and 34B may be covered with a cover material such as a cloth, leather, vinyl or other covering material. The first and second seat backs 28A and 28B may be fixed in the seating position, in one example, or may be released and pivoted down to a horizontal position to access the area behind the seat, according to another example.

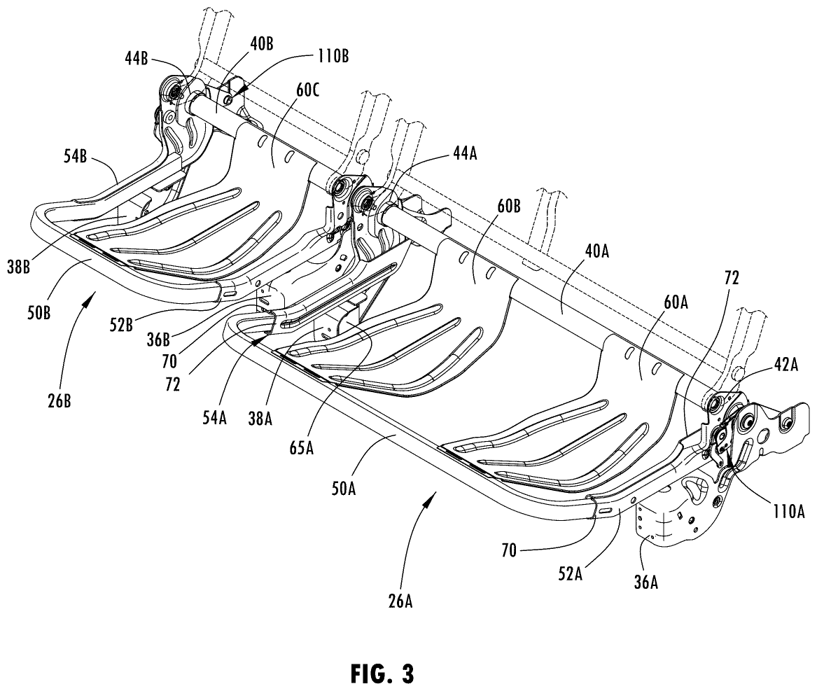

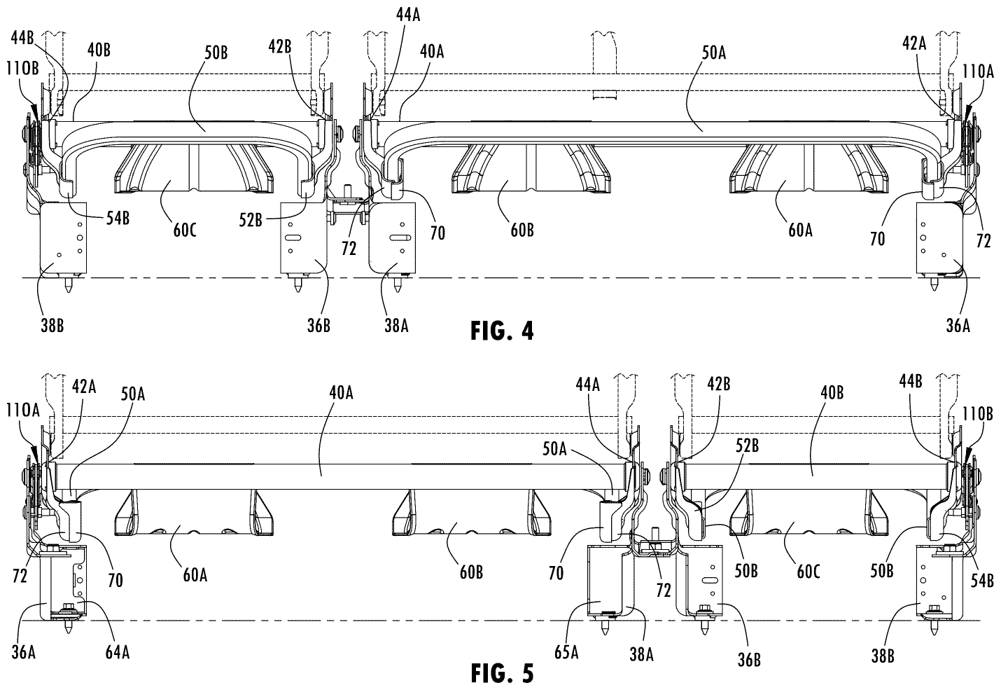

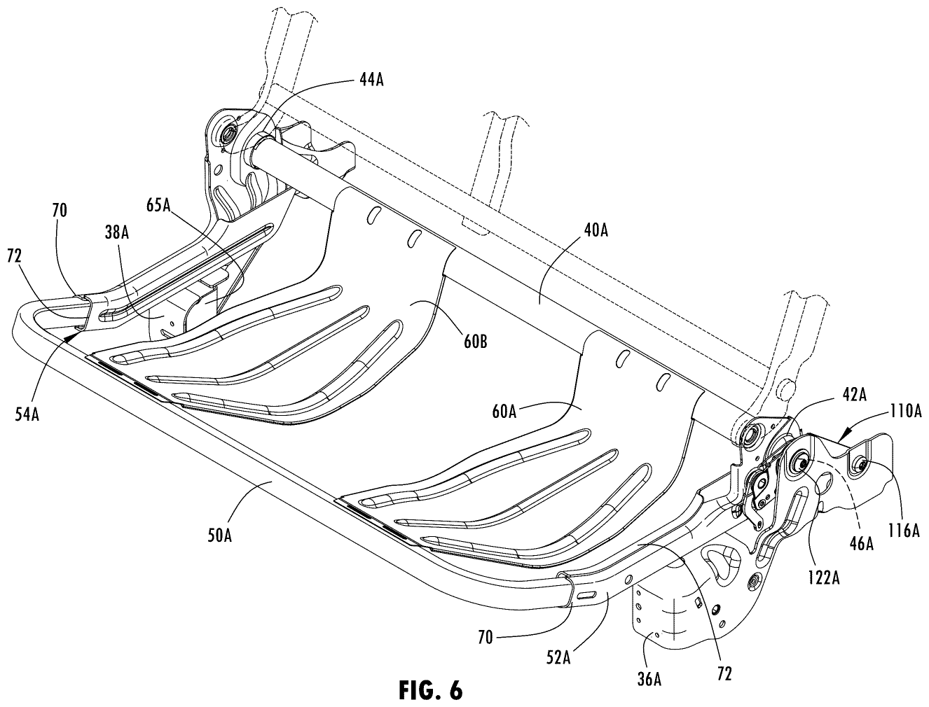

Referring to FIGS. 3-6, the first and second seat bases 26A and 26B are illustrated each having a front cushion tube and a rear cushion tube that define the perimeter of the seat base support frame. Specifically, the first seat base 26A has a U-shaped front cushion tube 50A that is generally rectangular in cross-section and extends forward from a rear cushion tube 40A. The second seat base 26B has a U-shaped front cushion tube 50B that extends forward from a rear cushion tube 40B. The front cushion tubes 50A and 50B each have a slight incline at the front end and may be made of a single layer of high strength metal such as a metal alloy having boron, for example. The front cushion tube 50A is coupled to the rear cushion tube 40A at tube connectors 42A and 44A. The front cushion tube 50B is coupled to the rear cushion tube 40B at tube connectors 42B and 44B. The tube connectors 42A, 44A, 42B and 44B may each be provided as an opening in a bracket receiving the end of the tube which is welded to the bracket. The rear cushion tubes 50A and 50B are each shown having a circular cross section. The front cushion tubes 50A and 50B and rear cushion tubes 40A and 40B rotate about the base brackets 36A and 36B and 38A and 38B which enables the front cushion tube 50A to rotate between the seating configuration shown and an upward stowed position.

The first seat base 26A includes a first seat pan 60A and a second seat pan 60B which are both connected to and supported by the rear cushion tube 40A and the front cushion tube 50A. The first and second seat pans 60A and 60B extend between the front and rear cushion tubes 50A and 40A. The first seat pan 60A has a downward curved contoured portion that forms a first seat support at a first seating location and the second seat pan 60B forms a second downward curved contoured seat support at a second seating position. It should be appreciated that the seat cushion 32A and a covering is supported on top of the front cushion tube 50A, rear cushion tube 40A, and the first and second seat pans 60A and 60B.

The first seat base 26A is supported on the floor 20 by a support structure on each end that includes the first support bracket 36A on one end and the second support bracket 38A on the opposite end. Each of the first and second support brackets 36A and 38A may be fastened to the floor 20 using fasteners such as bolts, for example. The first and second support brackets 36A and 38A advantageously support both the seat assembly 24A and the load on the seat assembly 24A and provide a support structure under the front cushion tube 50A that may contact the front cushion tube 50A and prevent downward movement of the front cushion tube 50A to an excessive downward position in the seating position.

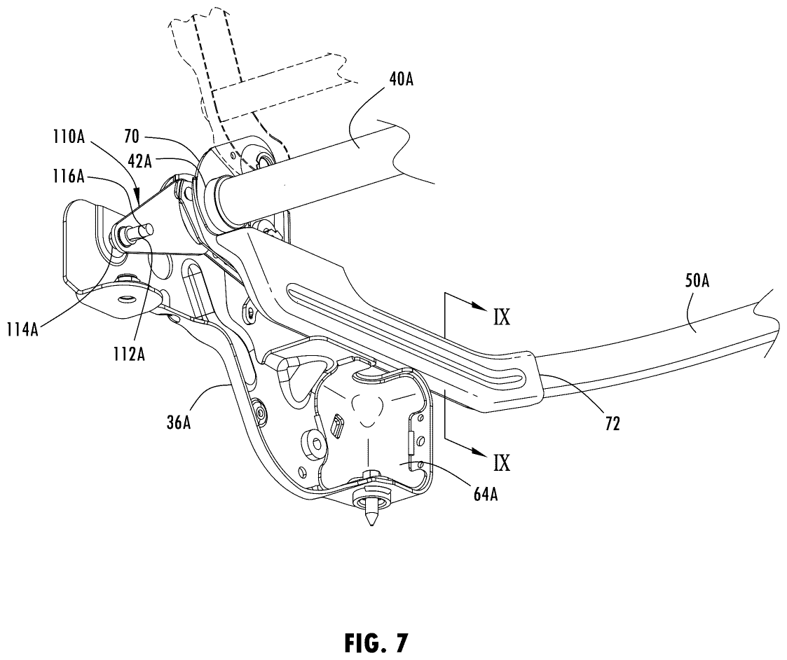

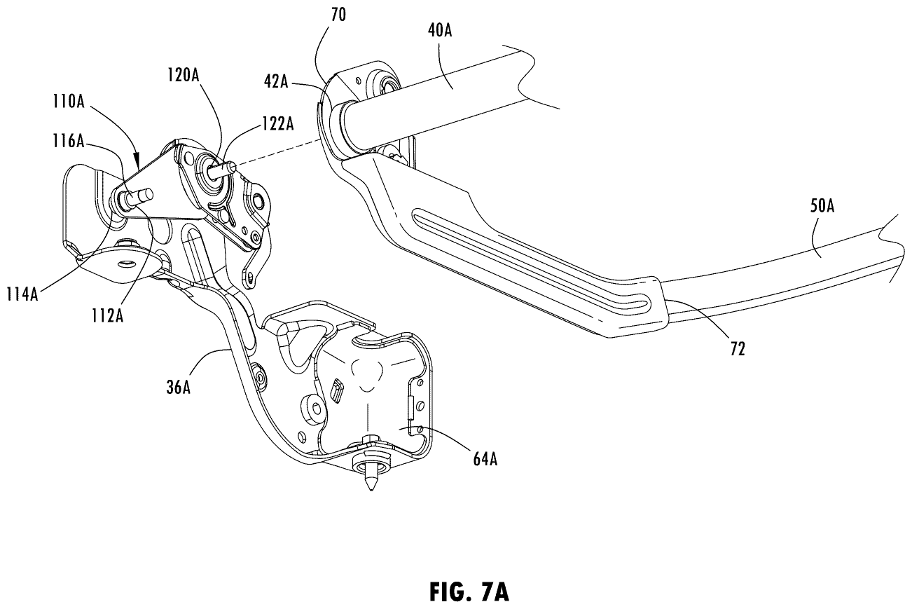

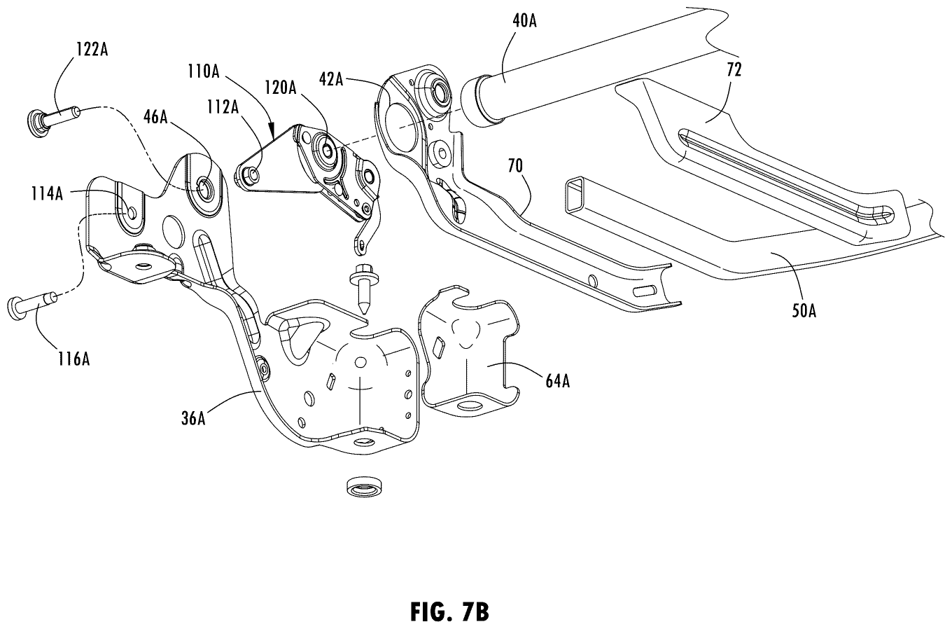

The front cushion tube 50A is further supported along the lateral sides via first and second pivot brackets 52A and 54A that are pivotably coupled to the base support brackets 36A and 38A. The first pivot bracket 52A is provided on one lateral side of the front cushion tube 50A and includes an opening and weld connection that serves as the tube connector 42A which supports the rear cushion tube 40A. The first pivot bracket 52A substantially surrounds a lateral portion of the front cushion tube 50A to provide reinforcement to prevent the front cushion tube 50A from excessive bending or flexing downward due to excessive loads. The first pivot bracket 52A may include a first bracket arm 70 and a second bracket arm 72 wrapped around the front cushion tube 50A as shown in FIGS. 7A, 7B, 8A, 8B, 9 and 9A, for example. As shown, the first pivot bracket 52A substantially surrounds and supports the front cushion tube 50A. It should be appreciated that the first bracket arm 70 and second bracket arm 72 may advantageously be connected together via welding or fasteners.

The second pivot bracket 54A extends along a lateral portion of the front cushion tube 50A on the opposite lateral side. The second pivot bracket 54A extends forward and includes an opening and a weld connection that serves as the tube connector 44A and supports the front cushion tube 50A on the opposite lateral side. The second pivot bracket 54A may likewise include first and second bracket arms 70 and 72 wrapped around the first cushion tube 50A as shown in FIGS. 7A, 7B, 8A, 8B, 9 and 9A which may be welded or otherwise fastened together to substantially surround front cushion tube 50A and support the front cushion tube 50A to prevent excessive bending or flexing downward.

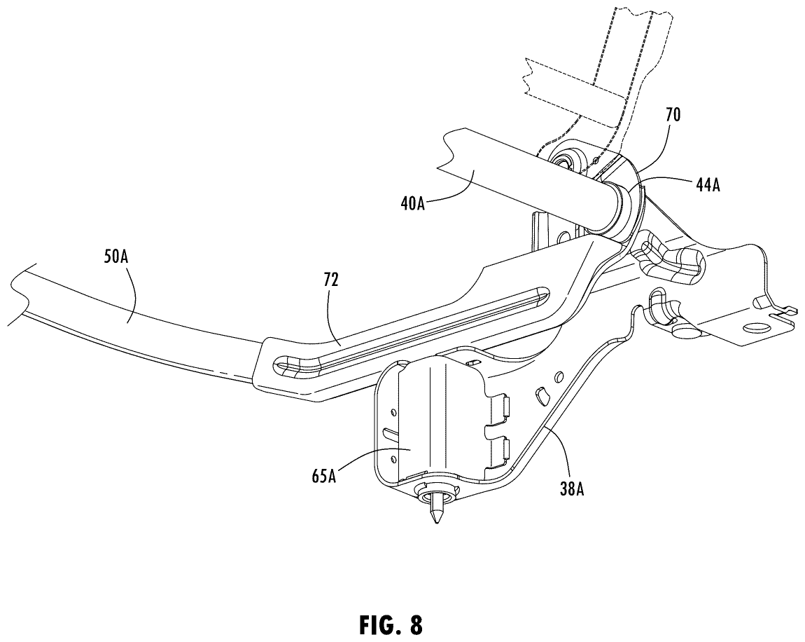

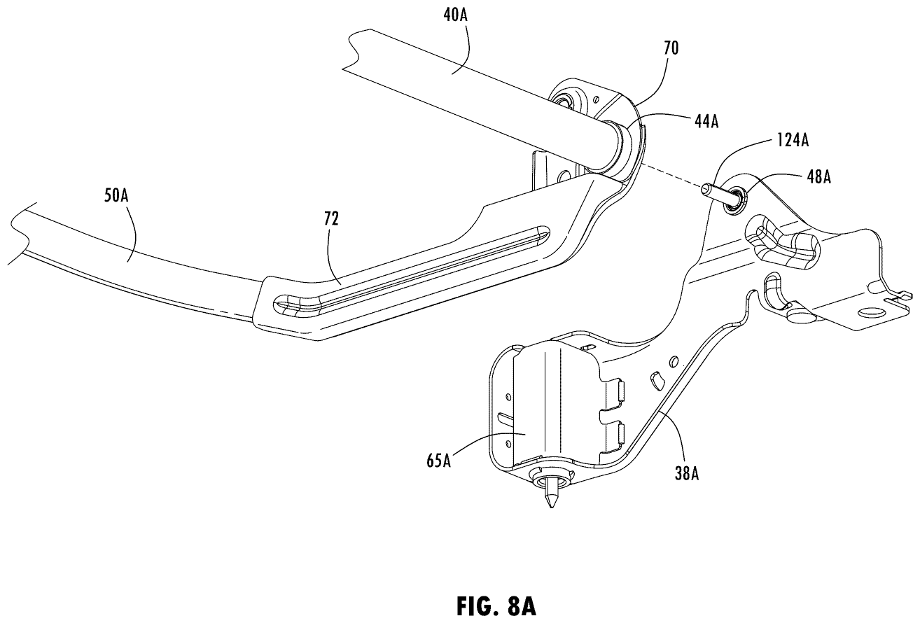

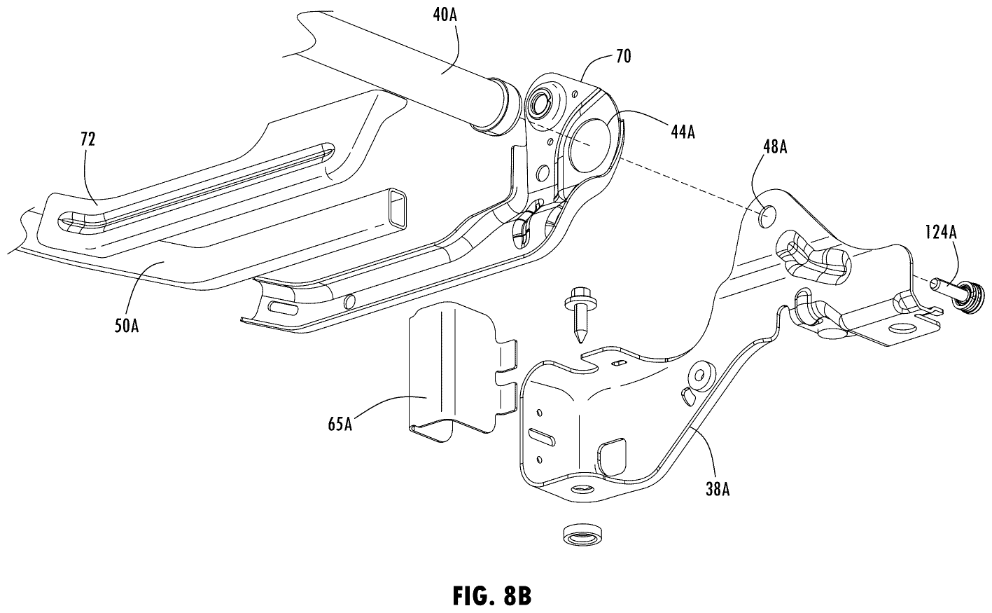

The base support brackets 36A and 38A may include reinforced internal support bracket structures. For example, the base support bracket 36A shown in FIGS. 7, 7A and 7B may include internal support bracket structures 64A to provide enhanced strength and rigidity to the base support bracket 36A. The base support bracket 36B may likewise include a reinforced internal support structure 64B as shown in FIGS. 8, 8A and 8B. The internal support bracket structures 64A and 64B may be made of a high strength steel such as a steel alloy containing Boron, for example. As such, the base support structure brackets 36A and 36B advantageously support the seating assembly 24A and provide sufficient internal reinforcement to prevent the front cushion tube 50A from bending or flexing excessively downward.

One end of the rear cushion tube 40A is welded to the first pivot bracket 54A within an opening which provides the tube connector 42A such that the front cushion tube 50A and rear cushion tube 40A rotate in sync with the first pivot bracket 52A. As seen in FIGS. 7, 7A and 7B, the rear cushion tube 40A and first pivot bracket 52A connect to a latch 110A via a fastener 122A which extends through opening 46A in the base support bracket 36A and opening 120A in latch 110A to engage the rear cushion tube 40A on one end. In addition, the latch 110A is fastened to the base support bracket 36A with a fastener 116A extending through opening 114A and opening 112A in latch 110A. As such, the latch 110A rotates with the seat base 26A between the seating and stowed positions and may include a pull cord to release the seat base from a latch position in the stowed position.

The opposite end of the rear cushion tube 40A and front cushion tube 50A are likewise connected to the second pivot bracket 54A and base support bracket 38A as shown in FIGS. 8, 8A and 8B. One end of the rear cushion tube 40A is welded to the first pivot bracket 54A within an opening that provides the tube connector 42A such that the front cushion tube 50A and rear cushion tube 40A rotate in sync with the first pivot bracket 54A. The rear cushion tube 40A and first pivot bracket 54A connect via a fastener 124A which extends through an opening 48A in the base support bracket 38A and opening 120A in latch 110A to engage the rear cushion tube 40A on one end. As such, the seat base 26A rotates between the seating and stowed positions.

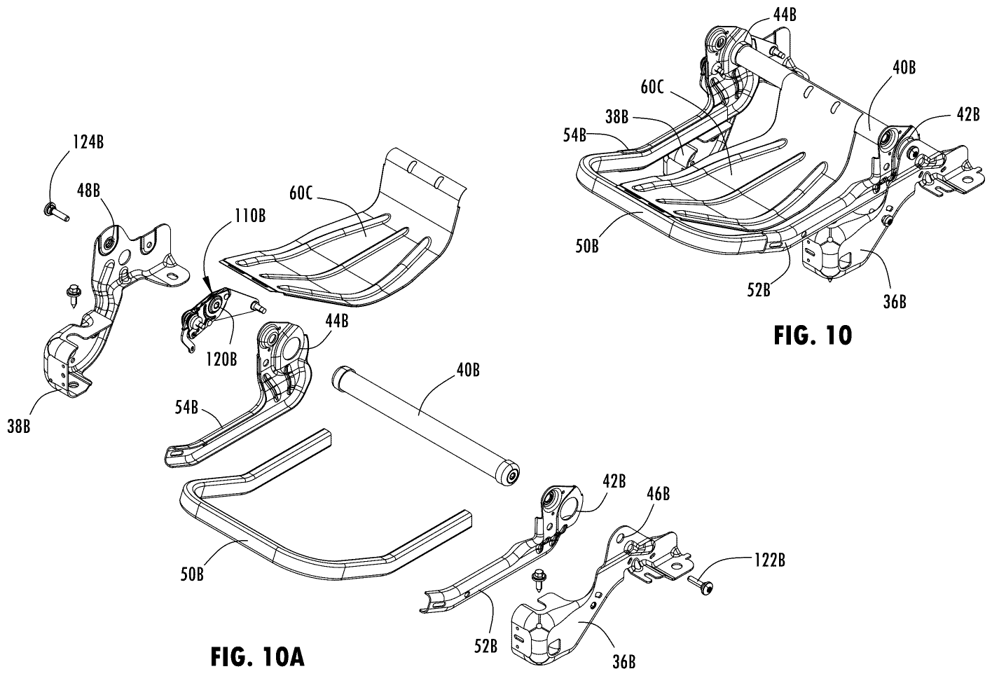

The second seat base 26B is illustrated in FIGS. 10 and 10A likewise having a front cushion tube 50B and a rear cushion tube 40B. The rear cushion tube 40B is connected to the pivot brackets 52B and 54B which are pivotably coupled to the support structure and the front cushion tube 50B similar to the assembly of the first seat base 26B. The base support structure similarly includes a first base support bracket 36B and a second base support bracket 38B. The first and second base support brackets 36B and 38B may be mounted to the vehicle floor 20 via fasteners 62, such as bolts, according to one example. The first and second base support brackets 36B and 38B support the rear cushion tube 40B, front cushion tube 50B and pivot brackets. The front cushion tube 50B extends forward from the rear cushion tube 40B with a U-shaped configuration that slightly inclines at the front end to define a third seat position in the second row seating 24. The front cushion tube 50A is shown having a rectangular cross section with rounded corners. A third seat pan 60C is shown extending between the rear cushion tube 40B and the front cushion tube 50B to define the third seating position.

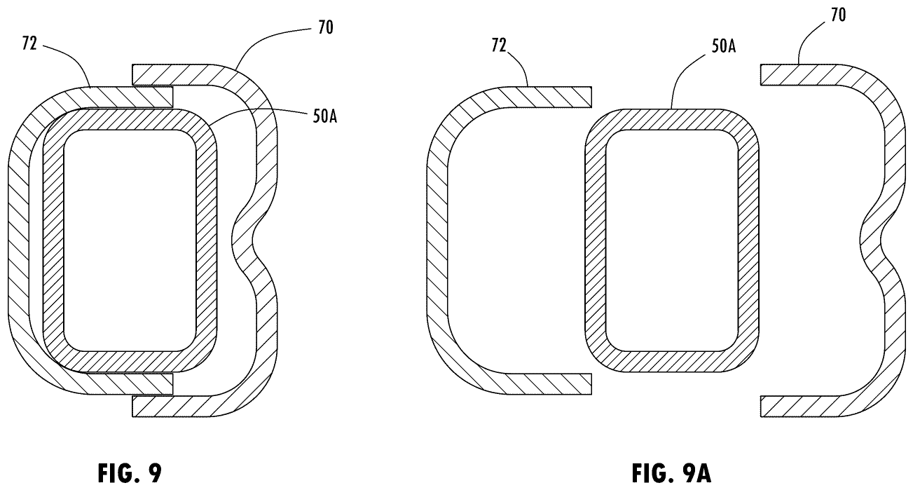

Similar to the first seat base 26A, the second seat base 26B has first and second pivot brackets 52B and 54B on opposite lateral sides supporting the forward extending portion of the front cushion tube 50B. The first pivot bracket 52B extends forward from the tube connectors 42B which is a welded connection within an opening and substantially surrounds a lateral portion of the front cushion tube 50B to provide added support to the lateral sides of the front cushion tube 50B. The second pivot bracket 54B likewise extends forward from the tube connector 44B which is a welded connection within an opening along a lateral portion of the front cushion tube 50B to provide support on the opposite lateral side of the front cushion tube 50B. The second pivot bracket 54B adjoins a latch 110B which allows the seat base to be latched in the stowed position. The pivot brackets 52B and 54B with front and rear cushion tubes 50B and 40B are pivotably coupled to base support brackets 36B and 38B via fasteners 122B and 124B extending through holes 46B and 48B. Each of the first and second pivot brackets 52B and 54B may include first and second bracket arms 70 and 72 that substantially surround the front cushion tube 50B and may be welded or otherwise connected together as shown in FIGS. 9 and 9A, for example. Accordingly, the first and second pivot brackets 52A and 54B advantageously support the front cushion tube 50B to prevent excessive downward bending or flexing, particularly when an excessive load is applied onto the seat pan 60C.

The base support brackets 36B and 38B provide a support frame for the entire seat 24B and provide a top surface that may prevent downward excessive motion of the front cushion tube 50B. In the example shown, the first and second base support brackets 36B and 38B on the second seat base 26B do not have the same internal support structure found on the first seat base 26A due to the lower load anticipated by defining a single seat as opposed to the two seats provided by the first seat base. As such, the expected load in the second seat base 26B can be less.

The vehicle seat assembly advantageously employs a seat base 26A or 26B that has a front cushion tube 50A or 50B that is sufficiently supported by one or more brackets to support the load on the seat base. The one or more brackets may include first and second pivot brackets 52A and 54A and the base support brackets 36A and 38A. By providing the first and second pivot brackets 52A and 54A as well as the base support brackets 36A and 38A, the front cushion tube 50A may employ a high strength single tubular member such as a metal alloy having Boron. This metal alloy allows for a lightweight, strong material to be used to support the seating load.

In the example shown, the first and second pivot brackets 52A, 54A, 52B and 54B each have a substantially rectangular cross-section with rounded corners, according to one example. It should be appreciated that other shapes and sizes of the first and second pivot support brackets 52A, 54A, 52B and 54B may be employed including circular and oval shape configurations, for example. Each of the first and second pivot support brackets 52A, 54A, 52B and 54B may have a thickness about 2.5 millimeters which may be formed with a hot stamping process. The material makeup may include a high strength material such as a steel alloy having Boron in the amount of at least 0.001 to 0.005 weight percent. The amount of Boron in the steel alloy may include Boron in the amount of 0.001 to 0.010 weight percent, for example. The Boron treated steel alloy may be formed using roll forming where the tube is roll-formed and welded together to create a tube like and may include pre-bending, heating, the use of a forming die, and form blow hardening and quenching techniques, for example. As a result of using a high strength material and the first and second pivot brackets, a high strength front cushion tube is provided that minimizes deflections due to load.

When either seat bases 24A or 24B are not being used to seat an occupant, the seat base 24A or 24B on the either side may be rotated upward to a stowed position to allow for enhanced storage within the cabin interior 14. It should further be appreciated that the front cushion tubes 50A and 50B may also allow for items to be suspended from the tube or otherwise supported and held below the seat base 24A and 24B when the seat bases 24A and 24B are in the seating position.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle seat assembly comprising:
a base support structure configured to be supported on a floor of a vehicle;
a rear cushion tube coupled to the base support structure;
a front cushion tube coupled to the rear cushion tube and defining a cushion support structure, the front cushion tube having a generally U-shaped portion with a first end and a second end, wherein the front cushion tube may rotate between a seating position and an upright stowed position;
a first pivot bracket pivotably coupling the first end of the front cushion tube to the base support structure; and
a second pivot bracket pivotably coupling the second end of the front cushion tube to the base support structure.

2. The vehicle seat assembly of claim 1, wherein the base support structure comprises at least one support bracket coupled to the base support structure and configured to support the underside of the front cushion tube in the seating position.

3. The vehicle seat assembly of claim 2, wherein the at least one support bracket comprises a first support bracket coupled to the base support structure on one end and a second support bracket coupled to the base support structure on an opposite second end.

4. The vehicle seat assembly of claim 1, further comprising at least one seat pan coupled to the rear cushion tube and the front cushion tube.

5. The vehicle seat assembly of claim 4, further comprising a seat cushion disposed on top of the front and rear cushion tubes and the at least one seat pan.

6. The vehicle seat assembly of claim 1, wherein the first and second pivot brackets are coupled to the rear cushion tube and comprise a sleeve cooperatively engaging the first and send ends, respectively, of the front cushion tube.

7. The vehicle seat assembly of claim 1, further comprising a seat back supported by the base support structure.

8. The vehicle seat assembly of claim 1, wherein the front cushion tube comprises Boron.

9. The vehicle seat assembly of claim 8, wherein the front cushion tube comprises a steel alloy having Boron in an amount of 0.001 to 0.005 weight percent.

10. The vehicle seat assembly of claim 8, wherein the front cushion tube comprises a metal alloy having Boron in an amount of 0.001 to 0.010 weight percent.

11. The vehicle seat assembly of claim 1, wherein the first and second pivot brackets comprise a steel alloy having Boron.

12. The vehicle seat assembly of claim 1, wherein the front cushion tube has a generally rectangular cross-section.

13. A vehicle seat assembly comprising:
a base support structure configured to be supported on a floor of a vehicle;
a rear cushion tube coupled to the base support structure;
a front cushion tube coupled to the lateral extending rod and defining a cushion support structure, the front cushion tube having a generally U-shaped portion with a first end and a second end, wherein the front cushion tube may rotate between a seating position and an upright stowed position;
a first pivot bracket pivotably coupling the first end to the base support structure; and
a second pivot bracket pivotably coupling the second end of the front cushion tube to the base support structure, wherein the at least one support bracket comprises a first support bracket coupled to the base support structure on one end and a second support bracket coupled to the base support structure on an opposite second end.

14. The vehicle seat assembly of claim 13, further comprising at least one seat pan coupled to the rear cushion tube.

15. The vehicle seat assembly of claim 14, further comprising a seat cushion disposed on top of the front and rear cushion tubes and the at least one seat pan.

16. The vehicle seat assembly of claim 13, wherein the first and second pivot brackets comprise a sleeve cooperatively engaging the first and send ends, respectively, of the front cushion tube.

17. The vehicle seat assembly of claim 13, wherein the front cushion tube comprises Boron.

18. The vehicle seat assembly of claim 17, wherein the front cushion tube comprises a steel alloy having Boron in an amount of at least 0.001 to 0.005 weight percent.

19. The vehicle seat assembly of claim 18, wherein the cushion tube comprises a metal alloy having Boron in an amount of 0.001 to 0.010 weight percent.

20. The vehicle seat assembly of claim 13, wherein the front cushion tube has a generally rectangular cross-section.
